(19) United States
(12) Patent Application Publication
(10) Pub. No.: US 2007/0201416 A1
(43) Pub. Date: Aug. 30, 2007

(54) Methods and apparatus for a self-healing WLAN

(76) Inventor: Ajay Malik, Santa Clara, CA (US)

Correspondence Address: INGRASSIA FISHER & LORENZ, P.C., 7150 E. CAMELBACK, STE. 325, SCOTTSDALE, AZ, 85251, US

(21) Appl. No.: 11/364,857

(22) Filed: Feb. 27, 2006

(51) Int. Cl. H04Q 7/24

(52) U.S. Cl. 370/338

(57) ABSTRACT

A wireless access port within a WLAN is capable of self-healing by re-performing auto-channel selection (e.g., auto-channel selection in accordance with the 802.11 family of standards) if particular conditions are met, wherein the conditions are indicative of a signal degradation between a mobile unit and the access port. Auto-channel selection may be initiated in the event that the number of retries (i.e., retries to establish a connection between the mobile unit and the access port) exceeds a threshold retry value within a certain timeframe.

### TECHNICAL FIELD

The present invention relates generally to wireless local area networks (WLANs) and, more particularly, to a WLAN with self-healing channel selection capabilities.

### BACKGROUND

In recent years, there has been a dramatic increase in demand for mobile connectivity solutions utilizing various wireless components and wireless local area networks (WLANs). This generally involves the use of wireless access points that communicate with mobile devices using one or more RF channels.

When an access point is first installed and/or when it is first powered up, it typically undergoes an auto-channel selection procedure. This procedure attempts to find the best channel for communication, given local conditions (interference, signal-to-noise ratio, presence of neighboring access points, etc.)

Since there are a limited number of channels available for communication, and because these channels partially overlap (e.g., as is the case with the 802.11 family of standards), it is not uncommon for there to be interference between neighboring mobile units or other devices (such as microwave ovens and portable telephones) when such devices enter and leave the environment. Such interference reduces signal strength and greatly reduces effective data communication rates. But because the auto-channel selection only takes place during start-up, the access point remains on the previously-selected, now non-optimal channel.

Accordingly, it is desirable to provide systems that are capable of “self-healing” with respect to degradation of signal strength between an access point and a mobile unit. Furthermore, other desirable features and characteristics of the present invention will become apparent from the subsequent detailed description and the appended claims, taken in conjunction with the accompanying drawings and the foregoing technical field and background.

### BRIEF SUMMARY

In accordance with the present invention, a wireless access port within a WLAN is capable of self-healing by re-performing auto-channel selection (e.g., auto-channel selection in accordance with the 802.11 family of standards) if particular conditions are met, wherein the conditions are indicative of a signal degradation between a mobile unit and the access port. In one embodiment, auto-channel selection is initiated in the event that the number of retries (i.e., retries to establish a connection between the mobile unit and the access port) exceeds a threshold retry value within a certain timeframe.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of a wireless network useful in describing the present invention; and

FIG. 2 is a flowchart depicting a method in accordance with one embodiment of the present invention.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to signal processing, data transmission, signaling, network control, the 802.11 family of specifications, and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

In general, a wireless access port in accordance with the present invention is capable of self-healing by re-performing auto-channel selection (e.g., auto-channel selection in accordance with the 802.11 family of standards) if particular conditions are met, wherein the conditions are indicative of a signal degradation between a mobile unit and the access port. In one embodiment, auto-channel selection is initiated in the event that the number of retries (i.e., retries to establish a connection between the mobile unit and the access port) exceeds a threshold retry value within a certain timeframe.

Without loss of generality, in the illustrated embodiment, many of the functions usually provided by a traditional access point (e.g., network management, wireless configuration, and the like) are concentrated in a corresponding wireless switch. It will be appreciated that the present invention is not so limited, and that the methods and systems described herein may be used in conjunction with traditional access points or any other device that communicates via multiple RF channels.

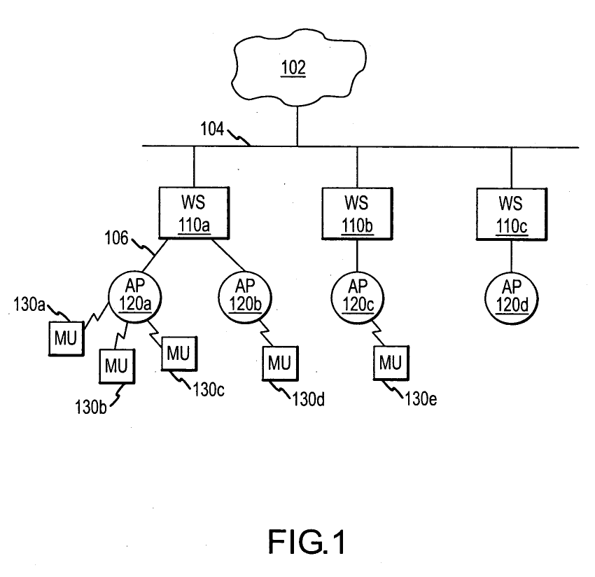

Referring to FIG. 1, one or more switching devices 110 (alternatively referred to as “wireless switches,” “WS,” or simply “switches”) are coupled to a network 104 (e.g., an Ethernet network coupled to one or more other networks or devices, indicated by network cloud 102). One or more wireless access ports 120 (alternatively referred to as “access ports” or “APs”) are configured to wirelessly connect to one or more mobile units 130 (or “MUs”). APs 120 are suitably connected to corresponding switches 110 via communication lines 106 (e.g., conventional Ethernet lines). Any number of additional and/or intervening switches, routers, servers and other network components may also be present in the system.

A particular AP 120 may have a number of associated MUs 130. For example, in the illustrated topology, MUs 130(a), 130(b), and 130(c) are associated with AP 120(a), while MU 130(e) is associated with AP 120(c). Furthermore, one or more APs 120 may be connected to a single switch 110. Thus, as illustrated, AP 120(a) and AP 120(b) are connected to WS 110(a), and AP 120(c) is connected to WS 110(b).

Each WS 110 determines the destination of packets it receives over network 104 and routes that packet to the appropriate AP 120 if the destination is an MU 130 with which the AP is associated. Each WS 110 therefore maintains a routing list of MUs 130 and their associated APs 130. These lists are generated using a suitable packet handling process as is known in the art. Thus, each AP 120 acts primarily as a conduit, sending/receiving RF transmissions via MUs 130, and sending/receiving packets via a network protocol with WS 110.

AP 120 is typically capable of communicating with one or more MUs 130 through multiple RF channels. This distribution of channels varies greatly by device, as well as country of operation. For example, in one U.S. embodiment (in accordance with 802.11(b)) there are fourteen overlapping, staggered channels, each centered 5 MHz apart in the RF band.

Since there are a limited number of RF channels available for communication, and because these channels partially overlap, it is not uncommon for there to be interference between neighboring MUs. Furthermore, it is not uncommon for other devices (such as microwave ovens and portable telephones) to affect signal strength. For example, consider MU 130b in FIG. 1. If 130b is set up and operating normally, the sudden insertion of MU 130c and/or MU 130d into neighboring locations (e.g., offices, conference rooms, or the like), may cause interference on the channel used by MU 130b and AP120a. In accordance with the present invention, the system is capable of re-initiating an auto-channel selection procedure in order to “self-heal” this degradation in signal.

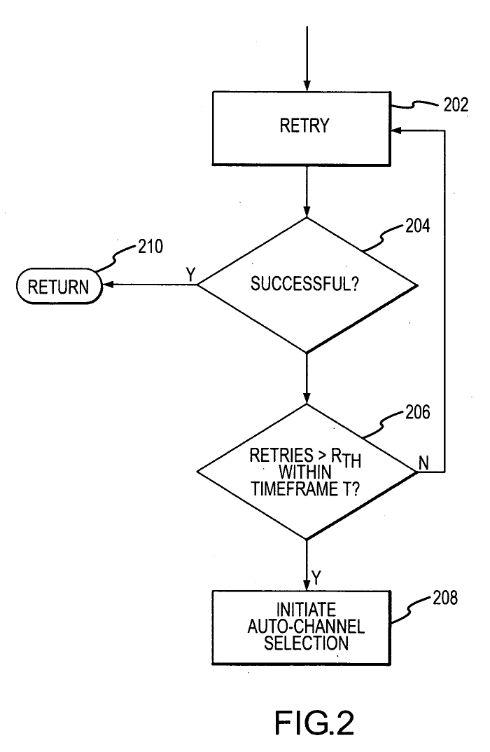

Toward this end, an exemplary self-healing WLAN method will now be described in conjunction with FIG. 2. The various tasks performed in connection with process shown in FIG. 2 may be performed by software, hardware, firmware, or any combination thereof, and may be located in the AP, the MU, the WS, or in any combination thereof. It should be appreciated that the process may include any number of additional or alternative tasks, that the tasks shown in FIG. 2 need not be performed in the illustrated order, and that the illustrated process may be incorporated into a more comprehensive procedure or process having additional functionality not described in detail herein.

With reference to FIG. 2, the method begins by retrying the connection from an MU 130 to an AP 120 (step 202). That is, it is assumed in FIG. 2 that the system previously determined that the RF connection between an AP and the associated MU had degraded to such an extent that a retry was necessary. This determination may be made by MU 130, AP 120, and/or WS 110. In a particular embodiment, the decision to retry the connection is made by AP 120.

After AP 120 attempts a retry, this retry will either be successful (“Y” branch from step 204) or unsuccessful (“N” branch from step 204). If the retry is successful, the system returns to normal operation (step 210). If the retry is unsuccessful, the system them proceeds to decision branch 206, where the number of retries is evaluation.

More particularly, at step 206 the system (e.g., the AP) tests whether the certain predetermined conditions have been met—i.e., conditions indicative of signal degradation between the MU and corresponding AP. In one embodiment, these conditions include a test of whether the number of retries have exceeded some predetermined threshold (R_{TH}) within a given timeframe T. The AP (which would typically include a microprocessor, memory, and other convention electronic components) keeps a record of the number of retries, along with the time (or time range) that those retries occur. The system might clear the count of retries after a successful retry (and look only at successive retries), or may keep a running total of retries over a period of time greater than T. The conditions necessary to initiate auto-channel selection may be stored in the specific AP 130, but might also be stored in a WS 110 or other networked device.

The selection of R_{TH} and T may depend upon the nature of the MU, the AP, the environment, or any other factor. In one embodiment, for example, R_{TH} is 5000 retries, and T is 3 minutes. Thus, in such an embodiment, the conditions would be met if about 15 retries had been attempted within a zero to 65535-second time limit. It will be appreciated, however, that the invention is limited to these values.

The values for R_{TH} and T may be hard-wired into the unit or, more preferably, configurable via a suitable interface. In one embodiment, for example, an administrator can configure these values for a particular AP via the corresponding WS 110.

If the system finds that the predetermined conditions have not been met (“N” branch from step 206), then processing continues with step 202, where the system attempts another retry. Alternatively, if the system finds that the predetermined conditions have been met (“Y” branch from step 206), then the system initiates an auto-channel selection procedure (step 208).

In general, the auto-channel selection procedure (step 208) involves testing of all or a subset of the available RF channels by MU 130 and AP 120 to determine which channel is substantially optimal for communication. This might involve, for example, stepping sequentially through all channels available for AP, then selecting the channel that had the best characteristics (e.g., channel strength, noise level, etc.). The testing of channels might be sequential, but might also be random or based on a priori knowledge of the existing network (i.e., knowledge re channels used by nearby devices).

In one embodiment, wherein AP conforms to one or more of the 802.11 family of specifications, the auto-channel selection procedure is carried out in accordance with the 802.11 specification. After the auto-channel selection procedure of step 208 is complete, the system returns to normal operation.

It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A method for self-healing in a wireless local area network of the type including a wireless access port and a mobile unit capable of wirelessly communicating with the wireless access port via multiple channels, the method comprising:
initiating an auto-channel selection procedure between the wireless access port and the mobile unit in the event that predetermined conditions are met, wherein said predetermined conditions are indicative of signal degradation between the wireless access port and the mobile unit.

2. The method of claim 1, further including:
counting a number of retries between the wireless access port and the mobile unit; and
initiating the auto-channel selection procedure if said number of retries within a predetermined time period exceed a retry threshold.

3. The method of claim 2, wherein the predetermined time period and retry threshold are manually configurable within the wireless access port.

4. The method of claim 1, wherein the number of channels is fourteen.

5. The method of claim 2, wherein the retry threshold is between approximately 0 and 15, and the predetermined time period is between approximately 0 and 65535 seconds.

6. The method of claim 1, wherein said auto-channel selection procedure includes:
determining an optimal channel;
configuring the mobile unit and the access point to communicate via said optimal channel.

7. A wireless access port comprising:
a self-heal module configured to initiate an auto-channel selection procedure in the event that predetermined conditions are met, wherein said predetermined conditions are indicative of signal degradation between the wireless access port and a mobile unit.

8. The access port of claim 7, wherein said self-heal module is further configured to count a number of retries between the wireless access port and the mobile unit; and initiate the auto-channel selection procedure if said number of retries within a predetermined time period exceed a retry threshold.

9. The access port of claim 8, wherein the retry threshold is between approximately 0 and 15, and the predetermined time period is between approximately 0 and 65535 seconds.

10. A wireless local area network (WLAN) comprising:
a switching device coupled to a network;
a wireless access point coupled to the wireless switch;
a mobile unit configured to wireless communicate with the wireless access point, said mobile unit further configured to initiate an auto-channel selection procedure in the event that predetermined conditions are met, wherein said predetermined conditions are indicative of signal degradation between the wireless access port and a mobile unit.

11. The WLAN of claim 10, wherein said predetermined conditions are based on a count of retry attempts between the wireless access point and the mobile unit.

12. The WLAN of claim 11, wherein said predetermined conditions are further based on a time period within which said count of retry attempts occur.
